(19) United States
(12) Patent Application Publication
(10) Pub. No.: US 2009/0023687 A1
(43) Pub. Date: Jan. 22, 2009

(54) Method for Controlling Phytopathogenic Organisms

(75) Inventor: Ulrich Johannes Haas, Stein (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 11/996,978

(22) PCT Filed: Aug. 8, 2006
(86) PCT No.: PCT/EP2006/007850

§ 371 Date: Jun. 5, 2008

Related U.S. Application Data
(60) Provisional application No. 60/706,544, filed on Aug. 9, 2005.

(51) Int. Cl. A01N 57/20; A01N 43/54; A01N 43/828; A01N 43/707

(52) U.S. Cl. 514/114; 514/256; 514/361; 514/383

(57) ABSTRACT

The present invention is directed to methods of protecting crops of useful plants against attack by phytopathogenic organisms as well as the treatment of crops of useful plants infested by phytopathogenic organisms comprising administering a combination of glyphosate and at least one fungicide to the plant or locus thereof.

### FIELD OF THE INVENTION

The present invention is directed to methods of protecting crops of useful plants against attack by phytopathogenic organisms as well as the treatment of crops of useful plants infested by phytopathogenic organisms comprising administering a combination of glyphosate and at least one fungicide to the plant or locus thereof.

### BACKGROUND OF THE INVENTION

Crop yield can be adversely affected by disease. The use of fungicides to control disease and/or reduce the effects of disease on crops is an important part of modern agricultural practice. Diseases such as those of the order Uredinales, also referred to as rusts, can be particularly damaging to crops such as cereals, cotton and soybeans. The Uredinales have long attracted considerable interest in agriculture, horticulture and forestry, as they are parasites which have great economic impact.

It is known that certain fungicides have activity on at least some of the diseases of the order Uredinales and can be used for the control of rusts in crops of useful plants.

Glyphosate is the largest selling agrochemical in the global market. It finds uses for control of unwanted vegetation in virtually every agricultural production system, as well as in forestry, industrial, municipal, residential, rights-of-way, amenity and other applications. Glyphosate is an acid that is relatively insoluble in water. For this reason it is typically formulated as a water-soluble salt in aqueous solution. While there have been mixed reports regarding the fungicidal activity of glyphosate, the post-emergent application of glyphosate for controlling weeds in crops of glyphosate resistant plants is known.

### SUMMARY OF THE INVENTION

The present invention is directed to methods of protecting crops of useful plants against attack by phytopathogenic organisms as well as the treatment of crops of useful plants infested by phytopathogenic organisms comprising administering a combination of glyphosate and at least one fungicide to the plant or locus thereof, wherein the plant is resistant or sensitive to glyphosate.

The methods of the present invention provide unexpectedly improved control of diseases compared to using the fungicide in the absence of glyphosate. The methods of the present invention are effective at enhancing the fungicide's control of disease. While the mixture of glyphosate and at least one fungicide may increase the disease spectrum controlled, at least in part, by the fungicide, an increase in the activity of the fungicide on disease species already known to be controlled to some degree by the fungicide is the effect most often observed.

The methods of the present invention are particularly effective against the phytopathogenic organisms of the kingdom Fungi, phylum Basidiomycota, class Uredinomycetes, subclass Urediniomycetidae and the order Uredinales (commonly referred to as rusts). Species of rusts having a particularly large impact on agriculture include those of the family Phakopsoraceae, particularly those of the genus Phakopsora, for example Phakopsora pachyrhizi, which is also referred to as Asian soybean rust, and those of the family Pucciniaceae, particularly those of the genus Puccinia such as Puccinia graminis, also known as stem rust or black rust, which is a problem disease in cereal crops and Puccinia recondita, also known as brown rust.

An embodiment of the present invention is directed to a method of protecting crops of useful plants against attack by a phytopathogenic organism and/or the treatment of crops of useful plants infested by a phytopathogenic organism, said method comprising simultaneously applying glyphosate, including salts or esters thereof, and at least one fungicide having activity against the phytopathogenic organism to at least one member selected from the group consisting of the plant, a part of the plant and the locus of the plant, whereby the application of glyphosate and the at least one fungicide results in protection of said crops from phytopathogenic organisms and/or control and/or inhibition of infection of said crops resulting from the infestation of the phytopathogenic organisms.

One embodiment of the present invention is directed to a method of protecting crops of useful plants against attack by a phytopathogenic organism of the order Uredinales and/or the treatment of crops of useful plants infested by a phytopathogenic organism of the order Uredinales, said method comprising simultaneously applying glyphosate, including salts or esters thereof, and at least one fungicide having activity against phytopathogenic organisms of the order Uredinales to at least one member selected from the group consisting of the plant, a part of the plant and the locus of the plant.

The methods of the present invention result in unexpectedly improved fungicidal activity against phytopathogenic organisms compared to the activity obtained by using the fungicide alone.

### DETAILED DESCRIPTION OF THE INVENTION

Glyphosate is typically used in form of its monobasic, dibasic or tribasic salts. Dibasic salts, such as the diammonium salt, of glyphosate are useful in compositions of the invention, but monobasic salts are generally preferred. Of these, particularly preferred examples include the monosodium, monopotassium, monoammonium, mono(dimethylammonium), mono(ethanolammonium), mono(isopropylammonium) and mono(trimethylsulfonium) salts as well as mixtures thereof.

While one or more treatments with glyphosate can be used within the scope of the present invention, the rate of glyphosate applied in combination with the fungicide(s) will depend on the sensitivity of the plant to glyphosate and whether weed control is an objective in addition to the enhancement of the fungicidal activity. Enhanced fungicidal activity against the target pathogens can be obtained by applying mixtures of glyphosate and fungicides at levels of glyphosate having low phytotoxicity against the treated plant, including glyphosate sensitive plants, i.e., plants which may exhibit unacceptable levels of damage when exposed to rates of glyphosate typically used for weed control. When it is said that the glyphosate has low phytotoxicity, it is meant that the amount of the glyphosate used is insufficient to cause damage to the plant at levels that counterbalance or overwhelm the beneficial activity of the active agent. It is more preferred that the glyphosate, when applied, causes damage that is commercially insignificant. It is even more preferred that the glyphosate, when applied, causes no measurable damage. For weed control, the amount of glyphosate required will depend on a number of factors including co-herbicides present, crop tolerance, weed type, level of weed pressure, climatic conditions and the like. Rates up to the maximum total in-crop amount permitted by any applicable label can be used.

The plant and plant propagation material useful in the present invention can be a plant sensitive to levels of glyphosate conventionally used for weed control or glyphosate resistant plants made tolerant to glyphosate by conventional breeding or having a transgenic event that provides glyphosate resistance. Some examples of such preferred transgenic plants having transgenic events that confer glyphosate resistance are described in U.S. Pat. Nos. 6,040,497; 5,914,451; 5,866,775; 5,804,425; 5,776,760; 5,633,435; 5,627,061; 5,463,175; 5,312,910; 5,310,667; 5,188,642; 5,145,783; 5,094,945; 4,971,908; 4,940,835 and 4,535,060, all of which are incorporated by reference in their entirety. The use of “stacked” transgenic events in the plant is also contemplated.

Stacked transgenic events including additional herbicide-resistant traits such as resistance to HPPD-inhibitors, glufosinate and bromoxynil are widely used and described in readily available resources.

Genetically modified cotton plants also include those which express toxins from Bacillus thuringiensis (Bt) and which are consequently resistant to attack by certain harmful insects are known and are increasingly employed in commercial agriculture (see, for example, U.S. Pat. No. 5,322,938).

Any fungicide suitable for post-emergent application to the plant may be used in the methods of the present invention. It is preferred that the fungicide has low phytotoxicity against the plant that is treated. When it is said that the fungicide has low phytotoxicity, it is meant that the amount of the fungicide used is insufficient to cause damage to the plant at levels that counterbalance or overwhelm the beneficial activity of the active agent. It is more preferred that the fungicide, when applied in an efficacious amount, causes damage that is insignificant. It is even more preferred that the fungicide, when applied in an efficacious amount, causes no measurable damage.

In a preferred embodiment, the fungicides of the present invention comprise at least one member selected from the group consisting of azoles, 2-amino-pyrimidines, anilinopyrimidines, benzimidazoles, carboxamides, copper compounds, dicarboxamides, dithiocarbamates, guanidines, N-halomethylthiotetrahydrophthalimides, morpholines, nitrophenol-derivatives, organo-phosphorous derivatives, ortho-substituted phenyl- or thienyl-amide fungicides, pyridazines, pyrimidinyl carbinoles, pyrroles, strobilurins and triazolopyrimidine derivative fungicides as well as other fungicides including acibenzolar-S-methyl, anilazine, benthiavalicarb, blasticidin-S, chinomethionate, chloroneb, chlorothalonil, cyflufenamid, cymoxanil, dichlone, diclocymet, diclomezine, dicloran, diethofencarb, dimethomorph, flumorph, dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, cyazofamid, kasugamycin, mandipropamid, methasulfocarb, metrafenone, nicobifen, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide and the compound represented by formula B-1.1, described in WO 2004/016088:

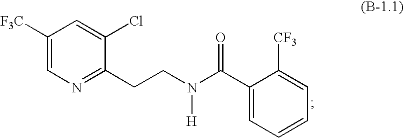

or a combination of any two or more of these fungicides or with other fungicides not listed.

Examples of azole fungicides suitable for use in the present invention include, without limitation, azaconazole, BAY 14120, bitertanol, bromuconazole, cyproconazole, difenoconazole, diniconazole, epoxiconazole, fenbuconazole, fluquinconazole, flusilazole, flutriafol, hexaconazole, imazalil, imibenconazole, ipconazole, metconazole, myclobutanil, pefurazoate, penconazole, prothioconazole, pyrifenox, prochloraz, propiconazole, simeconazole, tebuconazole, tetraconazole, triadimefon, triadimenol, triflumizole, triticonazole, as well as mixtures thereof.

Preferred azole fungicides include cyproconazole, difenaconazole, epoxiconazole, metconazole, myclobutanil, propiconazole, prothioconazole, tebuconazole and tetraconazole.

2-amino-pyrimidine fungicides suitable for use in the present invention include bupirimate, dimethirimol and ethirimol.

Anilinopyrimidine fungicides suitable for use in the present invention include cyprodinil, mepanipyrim and pyrimethanil.

Benzimidazole fungicides suitable for use in the present invention include benomyl, carbendazim, debacarb, fuberidazole and thiabendazole.

Carboxamide fungicides suitable for use in the present invention include carboxin, fenfuram, flutolanil, mepronil, oxycarboxin and thifluzamide.

Copper-compounds suitable for use in the present invention include Bordeaux mixture, copper hydroxide, copper oxychloride, copper sulfate, cuprous oxide, mancopper and oxine-copper.

Dicarboximides suitable for use in the present invention include chlozolinate, dichlozoline, iprodione, myclozoline, procymidone and vinclozoline;

Dithiocarbamate fungicides suitable for use in the present invention include ferbam, mancozeb, maneb, metiram, propineb, thiram, zineb and ziram.

Guanidine fungicides suitable for use in the present invention include guazatine, dodine and iminoctadine.

N-halomethylthiotetrahydrophthalimide fungicides suitable for use in the present invention include captafol, captan, dichlofluanid, fluoromides, folpet and tolyfluanid.

Morpholines suitable for use in the present invention include dodemorph, fenpropidine, fenpropimorph, spiroxamine and tridemorph.

Nitrophenol-derivatives suitable for use in the present invention include dinocap and nitrothal-isopropyl.

Organo-p-derivatives suitable for use in the present invention include edifenphos, iprobenphos, isoprothiolane, phosdiphen, pyrazophos and tolclofos-methyl.

Phenylamides suitable for use in the present invention include benalaxyl, furalaxyl, metalaxyl, metalaxyl-M, ofurace and oxadixyl.

Pyridazine fungicides suitable for use in the present invention are known and may be prepared by methods as described in WO 05/121104 and WO 06/001175. Preferred pyridazine fungicides include 3-Chloro-5-(4-chloro-phenyl)-6-methyl-4-(2,4,6-trifluoro-phenyl)-pyridazine (Formula P.1) and 3-Chloro-6-methyl-5-p-tolyl-4-(2,4,6-trifluoro-phenyl)-pyridazine (Formula P.2).

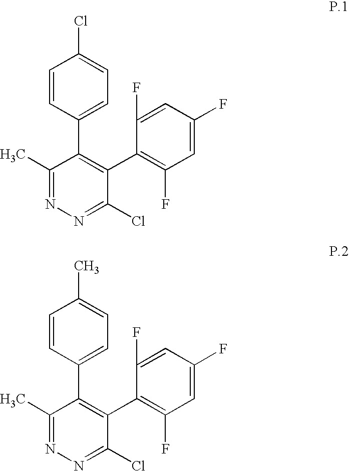

Pyrimidinyl carbinoles suitable for use in the present invention include ancymidol, fenarimol and nuarimol.

Pyrroles suitable for use in the present invention include fenpiclonil and fludioxonil.

Strobilurins suitable for use in the present invention include azoxystrobin, dimoxystrobin, enestroburin, fluoxastrobin, kresoxim-methyl, metominostrobin, orysastrobin, picoxystrobin, pyraclostrobin and trifloxystrobin.

Preferred strobilurin fungicides include azoxystrobin, picoxystrobin, pyraclostrobin and trifloxystrobin.

Suitable triazolopyrimidine derivatives include compounds of formula I:

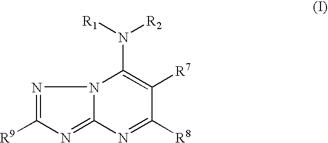

wherein
R¹ and R² together with the nitrogen atom to which they are attached form an optionally substituted heteromonocyclyl or heterobicyclyl;
R⁷ is an optionally substituted aryl or heteroaryl;
R⁸ is C₁-C₆alkyl, halogen or cyano;
R⁹ is hydrogen, mercapto or C₁-C₃alkylthio.

In the above definition heteromonocyclyl stands for monocyclic non-aromatic ring systems having 5 to 7 ring atoms selected from carbon, nitrogen, oxygen or sulphur, at least one of which being nitrogen, through which the heteromonocyclyl ring is linked to the [1,2,4]triazolo[1,5-a]pyrimidine. Examples are pyrrolodinyl, pyrrazolidinyl, oxazolidinyl, piperidinyl, piperazinyl and morpholin-4-yl.

In the above definition heterobicyclyl stands for annelated or bridged bicyclic non-aromatic ring systems having 5 to 10 ring atoms selected from carbon, nitrogen, oxygen or sulphur, at least one of which being nitrogen, through which the heterobicyclyl ring is linked to the [1,2,4]triazolo[1,5-a]pyrimidine. Examples are 2-azabicyclo[3.1.0]hexanyl, 3-azabicyclo[3.1.0]hexanyl, 3-azabicyclo[4.1.0]heptanyl, 8-azabicyclo[3.2.1]octanyl, 3-azabicyclo[3.2.1]octanyl, 2-azabicyclo[2.2.1]heptanyl and 3-azabicyclo[3.1.1]heptanyl.

Aryl stands for aromatic hydrocarbon rings like phenyl, naphthyl, anthracenyl, phenanthrenyl and biphenyl, with phenyl being preferred.

Heteroaryl stands for aromatic ring systems comprising mono-, bi- or tricyclic systems wherein at least one oxygen, nitrogen or sulfur atom is present as a ring member. Examples are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridyl, pyridazinyl, pyrimidinyl, pyrazinyl, triazinyl, tetrazinyl, indolyl, benzothiophenyl, benzofuranyl, benzimidazolyl, indazolyl, benzotriazolyl, benzothiazolyl, benzoxazolyl, quinolinyl, isoquinolinyl, phthalazinyl, quinoxalinyl, quinazolinyl, cinnolinyl and naphthyridinyl. Each heteroaryl can be linked by a carbon atom or by a nitrogen atom to the [1,2,4]triazolo[1,5-a]pyrimidine.

The above heteromonocyclyl, heterobicyclyl, aryl and heteroaryl groups may be optionally substituted. This means that they may carry one or more identical or different substituents. Normally not more than three substituents are present at the same time. Examples of substituents of heteromonocyclyl, heterobicyclyl, aryl or heteroaryl groups are: halogen, alkyl, haloalkyl, cycloalkyl, alkenyl, haloalkenyl, alkynyl, haloalkynyl, alkyloxy, haloalkyloxy, cycloalkoxy, alkenyloxy, haloalkenyloxy, alkynyloxy, haloalkynyloxy, alkylthio, haloalkylthio, cycloalkylthio, alkenylthio, alkynylthio, alkylcarbonyl, haloalkylcarbonyl, cycloalkylcarbonyl, alkenylcarbonyl, alkynylcarbonyl, alkoxyalkyl, cyano, nitro, hydroxy, mercapto, amino, alkylamino and dialkylamino.

Typical examples for heteromonocyclyl or heterobicyclyl include pyrrolidinyl, 2-methylpyrrodinyl, 3-methylpyrrolidinyl, oxazolidinyl, piperidinyl, 3-methylpiperidinyl, 4-methylpiperidinyl, piperidin-4-ol, 1-methylpiperazinyl, 2,6-dimethylmorpholin-4-yl, 6-methyl-3-azabicyclo[3.1.0]hexanyl, 6,6-dichloro-3-azabicyclo[3.1.0]hexanyl, 5-methyl-2-azabicyclo[3.1.0]hexanyl, 3-azabicyclo[4.1.0]heptanyl, 7-methyl-3-azabicyclo[4.1.0]heptanyl, 6-methyl-3-azabicyclo[4.1.0]heptanyl, 8-azabicyclo[3.2.1]octan-3-olyl, 3-methyl-8-azabicyclo[3.2.1]octanyl, 3-chloro-8-azabicyclo[3.2.1]octanyl and 3-azabicyclo[3.1.1]heptanyl.

Typical examples for aryl or heteroaryl include phenyl, 2-fluorophenyl, 2-chlorophenyl, 2-trifluoromethylphenyl, 2-methylphenyl, 2,3-difluorophenyl, 2,4-difluorophenyl, 2,5-difluorophenyl, 2,6-difluorophenyl, 2,3-dichlorophenyl, 2,4-dichlorophenyl, 2,5-dichlorophenyl, 2,6-dichlorophenyl, 2-chloro-3-fluorophenyl, 2-chloro-4-fluorophenyl, 2-chloro-5-fluorophenyl, 2-chloro-6-fluorophenyl, 3-chloro-2-fluorophenyl, 4-chloro-2-fluorophenyl, 5-chloro-2-fluorophenyl, 2-fluoro-3-trifluoromethylphenyl, 2-fluoro-4-trifluoromethylphenyl, 2-fluoro-5-trifluoromethylphenyl, 2-fluoro-6-trifluoromethylphenyl, 2-chloro-3-trifluoromethylphenyl, 2-chloro-4-trifluoromethylphenyl, 2-chloro-5-trifluoromethylphenyl, 2-chloro-6-trifluoromethylphenyl, 4-fluoro-2-trifluoromethylphenyl, 4-chloro-2-trifluoromethylphenyl, 2-fluoro-3-methylphenyl, 2-fluoro-4-methylphenyl, 2-fluoro-5-methylphenyl, 2-fluoro-6-methylphenyl, 2-chloro-3-methylphenyl, 2-chloro-4-methylphenyl, 2-chloro-5-methylphenyl, 2-chloro-6-methylphenyl, 4-fluoro-2-methylphenyl, 4-chloro-2-methylphenyl, 2,3,4-trifluorophenyl, 2,3,6-trifluorophenyl, 2,4,6-trifluorophenyl, 2,3,4-trichlorophenyl, 2,3,6-trichlorophenyl, 2,4,6-trichlorophenyl, 2,6-difluoro-4-methoxyphenyl, 2,6-difluoro-4-trifluoromethoxyphenyl, 2,6-difluoro-4-trifluoromethylphenyl, 2,6-difluoro-4-cyanophenyl, 2,6-difluoro-4-methylphenyl, 2,6-dichloro-4-methoxyphenyl, 2,6-dichloro-4-trifluoromethoxyphenyl, 2,6-dichloro-4-trifluoromethylphenyl, 2,6-dichloro-4-cyanophenyl, 2,6-dichloro-4-methylphenyl, pentafluorophenyl, 3,5-difluoropyridin-2-yl, 3,5-dichloropyridin-2-yl, 3-chloro-5-fluoropyridine-2-yl, 5-chloro-3-fluoropyridin-2-yl, 3-fluoro-5-trifluoromethylpyridin-2-yl, 3-chloro-5-trifluoromethylpyridin-2-yl, 2,4-difluoropyridin-3-yl, 2,4-dichloropyridin-3-yl, 2,4,6-trifluoropyridin-3-yl, 2,4,6-trichloropyridin-3-yl, 3,5-difluoropyridin-4-yl, 3,5-dichloropyridin-4-yl, 2,5-difluorothiophen-3-yl and 2,5-dichlorothiophen-3-yl.

In the above definition halogen is fluorine, chlorine, bromine or iodine.

The alkyl, alkenyl or alkynyl radicals may be straight-chained or branched.

Alkyl on its own or as part of another substituent is, depending upon the number of carbon atoms mentioned, for example, methyl, ethyl, propyl, butyl, pentyl, hexyl and the isomers thereof, for example, isopropyl, isobutyl, sec-butyl, tert-butyl, isopentyl or tert-pentyl.

A haloalkyl group may contain one or more identical or different halogen atoms and, for example, may stand for CH₂Cl, CHCl₂, CCl₃, CH₂F, CHF₂, CF₃, CF₃CH₂, CH₃CF₂, CF₃CF₂, CCl₃CCl₂, etc.

Cycloalkyl on its own or as part of another substituent is, depending upon the number of carbon atoms mentioned, for example, cyclopropyl, cyclobutyl, cyclopentyl or cyclohexyl.

Alkenyl on its own or as part of another substituent is, depending upon the number of carbon atoms mentioned, for example, ethenyl, allyl, 1-propenyl, buten-2-yl, buten-3-yl, penten-1-yl, penten-3-yl, hexen-1-yl or 4-methyl-3-pentenyl.

Alkynyl on its own or as part of another substituent is, depending upon the number of carbon atoms mentioned, for example, ethynyl, propyn-1-yl, propyn-2-yl, butyn-1-yl, butyn-2-yl, 1-methyl-2-butynyl, hexyn-1-yl or 1-ethyl-2-butynyl.

The presence of one or more possible asymmetric carbon atoms in the compounds of formula I means that the compounds may occur in optically isomeric, that means enantiomeric or diastereomeric forms. Also atropisomers may occur as a result of restricted rotation about a single bond. Formula I is intended to include all those possible isomeric forms and mixtures thereof.

In each case, the compounds of formula I according to the invention are in free form or in an agronomically usable salt form.

Table 1 below illustrates preferred individual compounds of formula I according to the invention.

TABLE 1
Preferred individual compounds of
formula I according to the invention

| Compound | | | | |
|---|---|---|---|---|
| No. | R¹—N—R² | R⁷ | R⁸ | R⁹ |
| 01 | 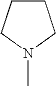 | 2,4,6-trifluorophenyl | Cl | H |
| 02 | 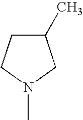 | 2,4,6-trifluorophenyl | Cl | H |
| 03 | 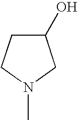 | 2,4,6-trifluorophenyl | Cl | H |
| 04 | 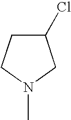 | 2,4,6-trifluorophenyl | Cl | H |
| 05 | 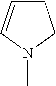 | 2,4,6-trifluorophenyl | Cl | H |
| 06 | 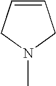 | 2,4,6-trifluorophenyl | Cl | H |
| 07 | 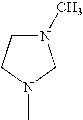 | 2,4,6-trifluorophenyl | Cl | H |
| 08 | 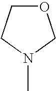 | 2,4,6-trifluorophenyl | Cl | H |
| 09 | 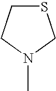 | 2,4,6-trifluorophenyl | Cl | H |
| 10 | 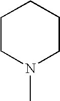 | 2,4,6-trifluorophenyl | Cl | H |
| 11 | 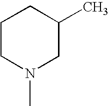 | 2,4,6-trifluorophenyl | Cl | H |
| 12 | 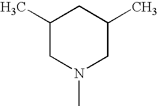 | 2,4,6-trifluorophenyl | Cl | H |
| 13 | 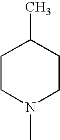 | 2,4,6-trifluorophenyl | Cl | H |
| 14 | 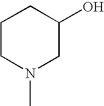 | 2,4,6-trifluorophenyl | Cl | H |
| 15 | 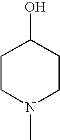 | 2,4,6-trifluorophenyl | Cl | H |
| 16 | 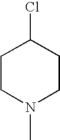 | 2,4,6-trifluorophenyl | Cl | H |
| 17 | 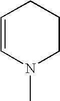 | 2,4,6-trifluorophenyl | Cl | H |
| 18 | 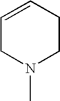 | 2,4,6-trifluorophenyl | Cl | H |
| 19 | 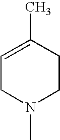 | 2,4,6-trifluorophenyl | Cl | H |
| 20 | 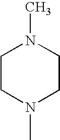 | 2,4,6-trifluorophenyl | Cl | H |
| 21 | 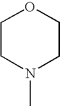 | 2,4,6-trifluorophenyl | Cl | H |
| 22 | 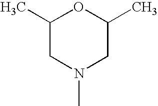 | 2,4,6-trifluorophenyl | Cl | H |
| 23 | 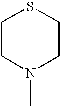 | 2,4,6-trifluorophenyl | Cl | H |
| 24 | 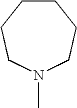 | 2,4,6-trifluorophenyl | Cl | H |
| 25 | 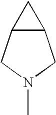 | 2,4,6-trifluorophenyl | Cl | H |
| 26 | 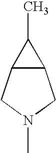 | 2,4,6-trifluorophenyl | Cl | H |
| 27 | 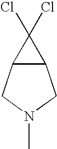 | 2,4,6-trifluorophenyl | Cl | H |
| 28 | 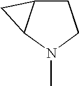 | 2,4,6-trifluorophenyl | Cl | H |
| 29 | 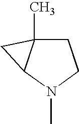 | 2,4,6-trifluorophenyl | Cl | H |
| 30 | 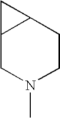 | 2,4,6-trifluorophenyl | Cl | H |
| 31 | 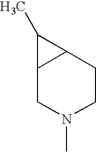 | 2,4,6-trifluorophenyl | Cl | H |
| 32 | 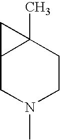 | 2,4,6-trifluorophenyl | Cl | H |
| 33 | 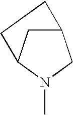 | 2,4,6-trifluorophenyl | Cl | H |
| 34 | 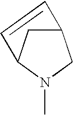 | 2,4,6-trifluorophenyl | Cl | H |
| 35 | 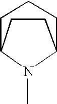 | 2,4,6-trifluorophenyl | Cl | H |
| 36 | 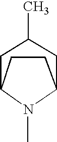 | 2,4,6-trifluorophenyl | Cl | H |
| 37 | 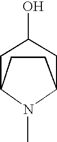 | 2,4,6-trifluorophenyl | Cl | H |
| 38 | 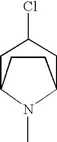 | 2,4,6-trifluorophenyl | Cl | H |
| 39 | 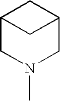 | 2,4,6-trifluorophenyl | Cl | H |
| 40 | 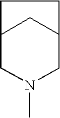 | 2,4,6-trifluorophenyl | Cl | H |

A preferred triazolopyrimidine for use in the present invention is Compound No. 13 of Table 1, represented by the following structure:

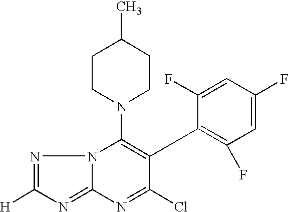

Ortho-substituted phenyl- or thienyl-amide fungicides suitable for use in the present invention include compounds of formula II

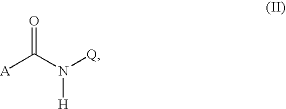

wherein A is

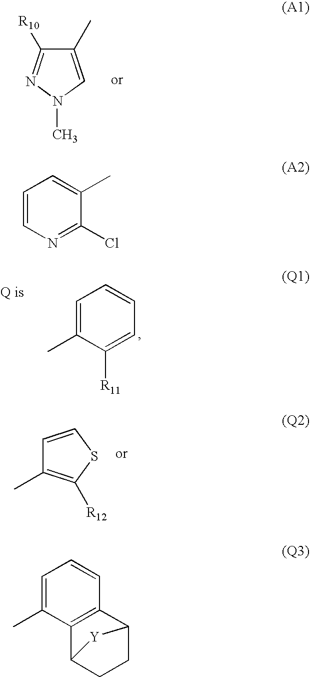

R₁₀ is difluoromethyl or trifluoromethyl;
R₁₁ is —CH₂—CH₂—CH(CH₃)₂, —CH(CH₃)—CH₂—CH(CH₃)₂, C₃₋₇cycloalkyl substituted by C₁₋₆alkyl or C₁₋₆haloalkyl; C₃₋₇cycloalkyl-C₃₋₇cycloalkyl or C₃₋₇cycloalkyl-C₃₋₇cycloalkyl substituted by C₁₋₆alkyl or C₁₋₆haloalkyl;
or R₁₁ is a phenyl group, which is substituted in the para-position by R₁₃;
R₁₃ is halogen or —C≡CR₁₄;
R₁₄ is C₁₋₆alkyl, C₁₋₆alkoxy-C₁₋₆alkyl or C₁₋₆haloalkyl;

### R₁₂ is —CH₂—CH₂—CH(CH₃)₂ or —CH(CH₃)—CH₂—CH(CH₃)₂;

### Y is —CHR₁₅—; and

R₁₅ is hydrogen or C₁₋₆alkyl.

In an embodiment of the invention A is A1.

In an embodiment of the invention A is A2.

In an embodiment of the invention Q is Q1.

In an embodiment of the invention Q is Q2.

In an embodiment of the invention Q is Q3.

Preferred compounds are compounds of formula II, wherein A is A1, Q is Q1 and R₁₁ is C₃₋₇cycloalkyl-C₃₋₇cycloalkyl.

Further preferred compounds are compounds of formula II, wherein A is A1, Q is Q3, Y is —CHR₁₅—, wherein R₁₅ is C₁₋₆alkyl.

Further preferred compounds are compounds of formula II, wherein A is A1, Q is Q1 and R₁₁ is a phenyl group, which is substituted in the para-position by R₁₃.

Further preferred compounds are compounds of formula II, wherein A is A2, Q is Q1 and R₁₁ is a phenyl group, which is substituted in the para-position by R₁₃.

Further preferred compounds of formula II are the following compounds:

a compound of formula F-1 (Boscalid)

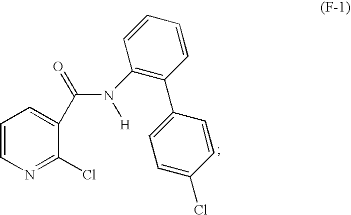

a compound of formula F-2

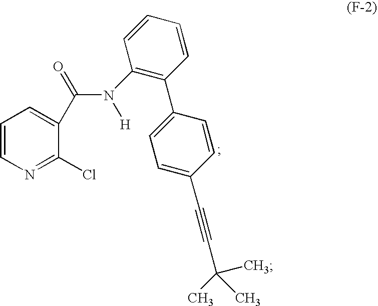

a racemic compound of formula F-3 (syn)

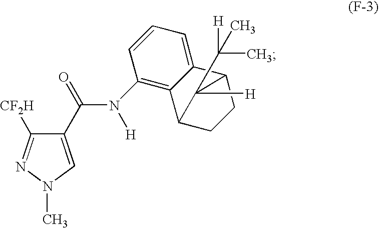

a racemic compound of formula F-4 (anti)

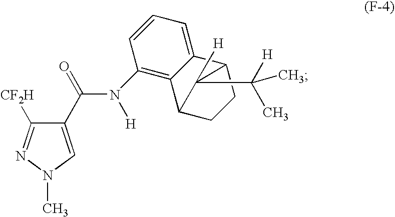

a compound of formula F-5

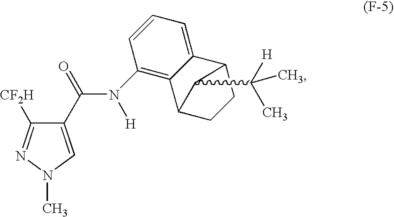

which represents an epimeric mixture of the racemic compounds of formula F-3 (syn) and F-4 (anti), wherein the ratio of racemic compounds of formula F-3 (syn) to racemic compounds of formula F-4 (anti) is from 1000:1 to 1:1000;
a compound of formula F-6

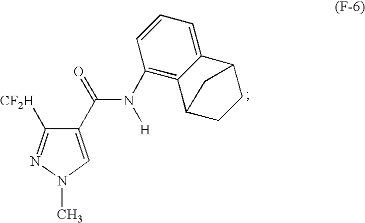

a racemic compound of formula F-7 (trans)

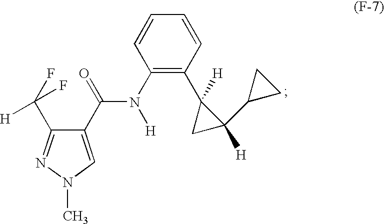

a racemic compound of formula F-8 (cis)

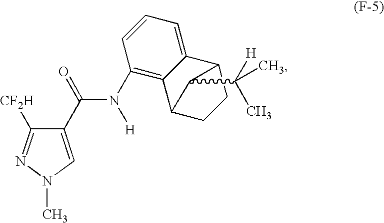

a compound of formula F-9

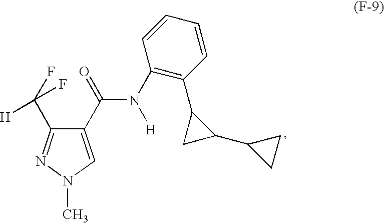

which represents a mixture of racemic compounds of formula F-7 (trans) and F-8 (cis), wherein the ratio of racemic compounds of formula F-7 (trans) to racemic compounds of formula F-8 (cis) is from 2:1 to 100:1;
a compound of formula F-10

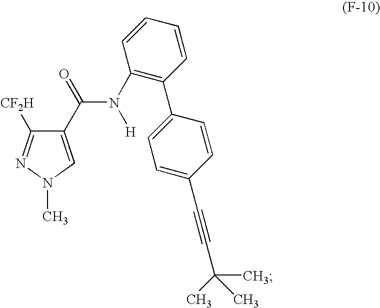

a compound of formula F-11

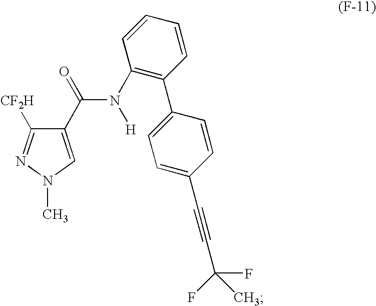

a compound of formula F-12

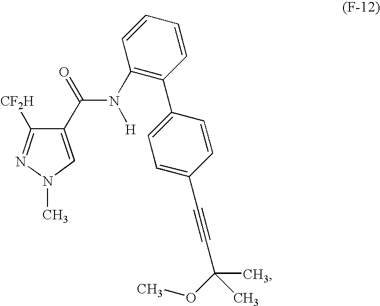

a compound of formula F-13

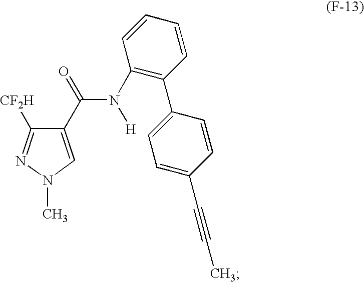

and a compound of formula F-14 (Penthiopyrad)

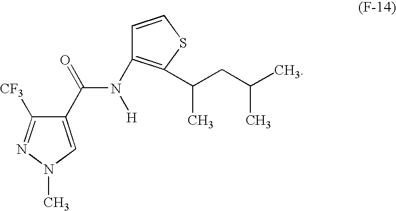

Compounds of formula II are known and may be prepared by methods as described in EP-0-545-099, EP-0-737-682, WO 04/058723, WO 04/035589, WO 03/074491 and WO 01/42223.

Preferred fungicides for use with glyphosate in the present invention comprise at least two fungicides selected from the group consisting of acibenzolar, chlorothalonil, mandipropamid, ortho-substituted phenyl- or thienyl-amide fungicides, strobilurin fungicides, azole fungicides, pyridazine fungicides and triazolopyrimidine derivative fungicides.

Preferred fungicides for use with glyphosate in the present invention comprise mixtures of azole fungicides as well as mixtures of azoles with at least one additional fungicide, for example, chlorothalonil. Preferred mixtures of azole fungicides include mixtures of propiconazole and cyproconazole.

Preferred mixtures of fungicides for use with glyphosate comprise mixtures of strobilurin fungicides and chlorothalonil.

Preferred fungicides for use with glyphosate in the present invention comprise a mixture of at least one azole fungicide and at least one member selected from the group consisting of chlorothalonil, ortho-substituted phenyl- or thienyl-amide fungicides, strobilurin fungicides, pyridazine fungicides and triazolopyrimidine derivative fungicides.

Preferred mixtures of the present invention comprising the ortho-substituted phenyl- or thienyl-amide fungicides include glyphosate, a racemic compound of formula F-3 (syn), and at least one fungicide selected from azoxystrobin, picoxystrobin, cyproconazole, difenoconazole, propiconazole, fludioxonil, cyprodinil, fenpropimorph, fenpropidin, a compound of formula F-15

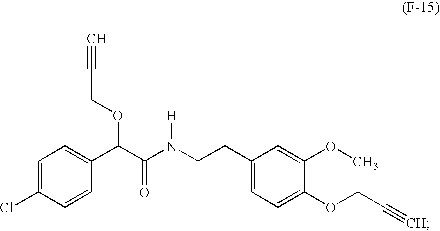

a compound of formula F-16

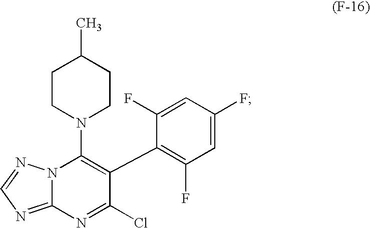

chlorothalonil, prothioconazole and epoxiconazole.

Preferred mixtures of the present invention comprising the ortho-substituted phenyl- or thienyl-amide fungicides include glyphosate, a racemic compound of formula F-4 (anti), and at least one fungicide selected from the group consisting of azoxystrobin, picoxystrobin, cyproconazole, difenoconazole, propiconazole, fludioxonil, cyprodinil, fenpropimorph, fenpropidin, a compound of formula F-15, a compound of formula F-16, chlorothalonil, prothioconazole and epoxiconazole.

Preferred mixtures of the present invention comprising the ortho-substituted phenyl- or thienyl-amide fungicides include glyphosate, a compound of formula F-5, which represents an epimeric mixture of the racemic compounds of formula F-3 (syn) and F-4 (anti), wherein the ratio of racemic compounds of formula F-3 (syn) to racemic compounds of formula F-4 (anti) is from 1000:1 to 1:1000, and at least one fungicide selected from the group consisting of azoxystrobin, picoxystrobin, cyproconazole, difenoconazole, propiconazole, fludioxonil, cyprodinil, fenpropimorph, fenpropidin, a compound of formula F-15, a compound of formula F-16, chlorothalonil, prothioconazole and epoxiconazole.

A further preferred mixture of the present invention comprises glyphosate; a compound of formula F-5, which represents an epimeric mixture of the racemic compounds of formula F-3 (syn) and F-4 (anti), wherein the ratio of racemic compounds of formula F-3 (syn) to racemic compounds of formula F-4 (anti) is from 1000:1 to 1:1000; cyproconazole; and propiconazole.

Further preferred mixtures of the present invention comprise glyphosate; a compound of formula F-5, which represents an epimeric mixture of the racemic compounds of formula F-3 (syn) and F-4 (anti), wherein the ratio of racemic compounds of formula F-3 (syn) to racemic compounds of formula F-4 (anti) is from 1000:1 to 1:1000; chlorothalonil; and at least one triazole fungicide selected from cyproconazole, difenoconazole, propiconazole, prothioconazole and epoxiconazole.

Preferred mixtures of the present invention comprising the ortho-substituted phenyl- or thienyl-amide fungicides include glyphosate, a racemic compound of formula F-7 (trans) and at least one fungicide selected from the group consisting of azoxystrobin, fludioxonil, difenoconazole, cyproconazole and thiabendazole.

Preferred mixtures of the present invention comprising the ortho-substituted phenyl- or thienyl-amide fungicides include glyphosate, a racemic compound of formula F-8 (cis) and at least one fungicide selected from the group consisting of azoxystrobin, fludioxonil, difenoconazole, cyproconazole and thiabendazole.

Preferred mixtures of the present invention comprising the ortho-substituted phenyl- or thienyl-amide fungicides include glyphosate, a compound of formula F-9, which represents a mixture of racemic compounds of formula F-7 (trans) and F-8 (cis), wherein the ratio of racemic compounds of formula F-7 (trans) to racemic compounds of formula F-8 (cis) is from 2:1 to 100:1, and at least one fungicide selected from the group consisting of azoxystrobin, fludioxonil, difenoconazole, cyproconazole and thiabendazole.

Preferred mixtures of the present invention comprising the ortho-substituted phenyl- or thienyl-amide fungicides include glyphosate, a compound of formula F-10 and at least one fungicide selected from the group consisting of azoxystrobin, picoxystrobin, cyproconazole, difenoconazole, propiconazole, fludioxonil, cyprodinil, fenpropimorph, fenpropidin, a compound of formula F-15, a compound of formula F-16, chlorothalonil, prothioconazole and epoxiconazole.

The compound of formula F-15 is described in WO 01/87822. The compound of formula F-16 is described in WO 98/46607.

In one embodiment, fungicides that are particularly suitable for use in the present invention include those that have demonstrated activity against phytopathogenic organisms of the order Uredinales.

While one or more treatments with fungicides can be used within the scope of the present invention, the amount of fungicide used and timing of application will vary based on numerous factors including the fungicide selected, region, climate, target disease, level of actual or expected disease pressure and crop and can readily be determined by one of ordinary skill. Each fungicide has a unique preharvest interval indicated on the product label. For control late in the season, one should ascertain the products preharvest interval before making an application. Combinations of a protectant fungicide and an early curative fungicide may be used and are effective against spore germination, host penetration and tissue colonization. Combinations of fungicides having different modes of action are also preferred in order to reduce the risk of fungicide resistance. In one embodiment of the present invention, at least one fungicide is applied to the plant, a part of the plant and/or the locus of the plant before and/or after the application of glyphosate and at least one fungicide. In one embodiment of the present invention, at least one fungicide is applied to the plant propagation material before the application of glyphosate and at least one fungicide.

In the case of soybeans, for example, glyphosate may be applied anytime from cracking through flowering up to the preharvest interval. The fungicides for controlling rust, for example, are preferably applied during the vegetative stage and from the beginning of flowering (R1) through full seed (R6).

The fungicides that are useful in the present invention can be used in any purity that passes for such fungicide in the commercial trade. The fungicide can be used in any form in which it is received from the supplier, or in which it is synthesized. It is preferred that the fungicide be supplied in the form of a liquid, which form includes, without limitations, solutions, suspensions and dispersions. However, the liquid can be a substantially pure form of the fungicide, or it can be the fungicide dissolved in a solvent. Commonly, if a solvent is present, such solvents are organic liquid solvents that are commonly used in such applications. If the fungicide is water soluble, then water can be used as the solvent.

Plants to be treated by the subject method can be treated with one or more forms of the useful active ingredients without any additional materials being present. However, in some cases, it is preferred to use the one or more active ingredients in combination with other materials in a composition.

Compositions of the present invention comprise an effective amount of one or more of the active ingredients described above and one or more adjuvants. If desirable, such compositions can also include such other materials as herbicides, insecticides, nematicides, acaricides, additional fungicides, fertilizers, and any other material that will provide a desirable feature for protecting, sprouting and. growing the plant. The choice of such other materials will depend on the crop and the pests known or thought to be a threat to that crop in the location of interest.

The compositions according to the invention are suitable for protecting crops of useful plants sensitive or resistant to glyphosate against attack by phytopathogenic organisms and/or the treatment of crops of useful plants sensitive or resistant to glyphosate infested by phytopathogenic organisms.

As used herein, the term “fungicide” shall mean a material that kills or materially inhibits the growth, proliferation, division, reproduction, or spread of fungi including, but not limited to, allergenic, toxinogenic and immunogenic fungi. As used herein, the term “prophylactic or fungicidally effective amount” or “amount effective to control or reduce fungi” in relation to the fungicidal compound is that amount that will kill or materially inhibit the growth, proliferation, division, reproduction, or spread of a significant number of fungi such as molds and, in particular, allergenic, toxinogenic or immunogenic varieties thereof in a target textile substrate

Selection of the fungicide(s) will depend upon the target phytopathogenic organisms. In an embodiment of the present invention, the efficacy of the selected fungicide(s) is increased by the addition of glyphosate to the composition. Representative classes of phytopathogenic fungi include: Fungi imperfecti (e.g. Botrytis spp., Alternaria spp.) and Basidiomycetes (e.g. Rhizoctonia spp., Hemileia spp., Puccinia spp., Phakopsora spp., Ustilago spp., Tilletia spp.). Additionally, the compositions of the invention are also effective against Ascomycetes (e.g. Venturia spp., Blumeria spp., Podosphaera leucotricha, Monilinia spp., Fusarium spp., Uncinula spp., Mycosphaerella spp., Pyrenophora spp., Rhynchosporium secalis, Magnaporthe spp., Colletotrichum spp., Gaeumannomyces graminis, Tapesia spp., Ramularia spp., Microdochium nivale, Sclerotinia spp.) and Oomycetes (e.g. Phytophthora spp., Pythium spp., Plasmopara spp., Pseudoperonospora cubensis). Furthermore, the compositions of the invention are effective against phytopathogenic bacteria and viruses (e.g. against Xanthomonas spp, Pseudomonas spp, Erwinia amylovora as well as against the tobacco mosaic virus).

In one embodiment, the compositions according to the invention are suitable especially for protecting crops of useful plants against attack by a phytopathogenic organism of the order Uredinales and/or the treatment of crops of useful plants infested by a phytopathogenic organism of the order Uredinales.

Phytopathogenic organisms of the order Uredinales controlled by the methods of the present invention are typically most damaging to specific crops and include, for example, in barley, crown rust (Puccinia coronata), leaf rust (Puccinia hordei), stem rust (Puccinia graminis) and stripe rust or yellow rust (Puccinia striiformis); in corn, common corn rust (Puccinia sorghi) and southern corn rust (Puccinia polysora); in cotton, cotton rust (Puccinia schedonnardi), Southwestern cotton rust (Puccinia cacabata) and tropical cotton rust (Phakopsora gossypii); in oats, crown rust (Puccinia coronata) and stem rust (Puccinia graminis); in rye, leaf rust or brown rust (Puccinia recondita) and stem rust (Puccinia graminis); in soybeans, Asian soybean rust (Phakopsora pachyrhizi); and in wheat, leaf rust or brown rust (Puccinia recondita), stem rust (Puccinia graminis) and stripe rust or yellow rust (Puccinia striiformis).

Mixtures comprising glyphosate and a compound of formula F-5 can be used advantageously to control/prevent the following diseases on wheat: Septoria tritici, Septoria nodorum, Erysiphe graminis, Pseudocercosporella herpotrichoides and/or Pyrenophora tritici-repentis; or the following diseases on barley: Rhynchosporium secalis, Erysiphe graminis, Pyrenophora teres and/or Ramularia collo-cygni; or the following diseases on oilseed rape: Sclerotinia sclerotiorum, Alternaria brassicae and/or Phoma lingam; or the following diseases on turf: Sclerotinia homeocarpa and/or Rhizoctonia solani; or the following diseases on apple: Venturia inequalis and/or Podosphaeria leucotricha; or the following diseases on grape: Botrytis cinerea and/or Unicinula necator; or the following diseases on soybeans: Septoria spp. and/or Cercospora spp.; or the following diseases on tomato or potato: Alternaria spp. and/or Rhizoctonia spp.; or the following diseases on leafy vegetables (such as cucurbits or brassicas): Alternaria spp., Sphaerotheca spp., Sclerotinia spp., Botrytis spp. and/or Phoma spp.; or Mycosphaerella fijiensis on Banana; or the following diseases on rice: Rhizoctonia solani and/or Pyricularia oryzae.

Mixtures comprising glyphosate, a compound of formula F-5 and a fungicide selected from the group consisting of azoxystrobin, picoxystrobin, cyproconazole, difenoconazole, propiconazole, fludioxonil, cyprodinil, fenpropimorph, fenpropidin, a compound of formula F-15, a compound of formula F-16, chlorothalonil, prothioconazole and epoxiconazole can be used advantageously to control/prevent the following diseases on wheat: Septoria tritici, Septoria nodorum, Erysiphe graminis, Pseudocercosporella herpotrichoides and/or Pyrenophora tritici-repentis; or the following diseases on barley: Rhynchosporium secalis, Erysiphe graminis, Pyrenophora teres and/or Ramularia collo-cygni; or the following diseases on oilseed rape: Sclerotinia sclerotiorum, Alternaria brassicae and/or Phoma lingam; or the following diseases on turf: Sclerotinia homeocarpa and/or Rhizoctonia solani; or the following diseases on apple: Venturia inequalis and/or Podosphaeria leucotricha; or the following diseases on grape: Botrytis cinerea and/or Unicinula necator; or the following diseases on soybeans: Septoria spp. and/or Cercospora spp.; or the following diseases on tomato or potato: Alternaria spp. and/or Rhizoctonia spp.; or the following diseases on leafy vegetables (such as cucurbits or brassicas): Alternaria spp., Sphaerotheca spp., Sclerotinia spp., Botrytis spp. and/or Phoma spp.; or Mycosphaerella fijiensis on Banana; or the following diseases on rice: Rhizoctonia solani and/or Pyricularia oryzae.

Crops of useful plants include any plants where protection from phytopathogenic organisms is desired. This includes those crop groups as set forth in the US Code of Federal Regulations, 40 C.F.R. 180.41 (Root and tuber vegetables; Leaves of root and tuber vegetables (human food or animal feed); Bulb vegetables (Allium spp.); Leafy vegetables (except Brassica vegetables); Brassica (cole) leafy vegetables; Legume vegetables; Foliage of legume vegetables; Fruiting vegetables; Cucurbit vegetables; Citrus fruits; Pome fruits; Stone fruits; Berries; Tree nuts; Cereal grains; Forage, fodder and straw of cereal grains; Grass forage, fodder, and hay; Non-grass animal feeds (forage, fodder, straw and hay); Herbs and spices). Crops of useful plant, as used herein, also include turf, shrubs, ornamentals and so forth associated with lawn and garden applications.

Preferred crops of useful plants include canola, cereals such as barley, oats, rye and wheat, cotton, maize, soya, fruits, berries, nuts, vegetables, flowers, trees, shrubs and turf. “Crops” are to be understood also to include those crops that have been made tolerant to glyphosate, pests and/or other pesticides, as a result of conventional methods of breeding or genetic engineering. The components used in the present invention can be applied in a variety of ways known to those skilled in the art, at various concentrations. The rate at which the compositions are applied will depend upon the particular type of pests to be controlled, the degree of control required, and the timing and method of application.

The following examples illustrate further some of the aspects of the invention but are not intended to limit its scope. Where not otherwise specified throughout this specification and claims, percentages are by weight.

### EXAMPLES

A synergistic effect exists whenever the action of an active ingredient combination is greater than the action expected from the effect of the individual components.

The action to be expected (E) for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per litre of spray mixture
X=% action by active ingredient I using p ppm of active ingredient
Y=% action by active ingredient II using q ppm of active ingredient.

According to Colby, the expected (additive) action of active ingredients I+II using p+q ppm of active ingredient is

$$E = X + Y - \frac{X \cdot Y}{100}$$

If the action actually observed (O) is greater than the expected action (E), then the action of the combination is superadditive, i.e. there is a synergistic effect.

### Example 1

### Leaf Disc Test with Phakopsora pachyrhizi on Glyphosate Resistant Soybean

A series of leaf disc tests were conducted to show the effects of tank mixtures of glyphosate and fungicides on Asian soybean rust. The soybean variety tested was NK Brand S40-R9 glyphosate resistant soybean. The leaf source for the testing was the first trifoliate leaf. Six (6) repetitions for each formulation and at each rate were conducted. Treatment of the leaf with the recited active ingredients was conducted 29 days after planting. The leaves were inoculated with Phakopsora pachyrhizi (Asian soybean rust (ASR)) one (1) day after treatment. Evaluation of the leaf was conducted ten (10) days after inoculation and the mean percent infestation of the six trials is reported in Table 1.

The glyphosate source was Zapp® QI herbicide (Syngenta Corp.), containing the potassium salt of glyphosate as well as an adjuvant system. The fungicide used was Priori® Xtra (Syngenta Corp.), which is a suspension concentrate containing 200 g/L of azoxystrobin (AZ) and 80 g/L of cyproconazole (CCZ). The rates of the active ingredients used in the tests are set forth in the Table as mg active ingredient (a.i.)/L.

TABLE 2
Glyphosate + Azoxystrobin + Cyproconazole

| | AZ/CCZ | Glyphosate | % | % Activity | % Activity |
|---|---|---|---|---|---|
| Test | (mg a.i./L) | (mg a.i./L) | Leaf attack | observed | expected |
| Check | — | — | 96 | | |
| 1 | 10 | | 2 | 98 | |
| 2 | 2.5 | | 13 | 86 | |
| 3 | 0.62 | | 23 | 76 | |
| 4 | 0.16 | | 30 | 69 | |
| 5 | 0.04 | | 67 | 30 | |
| 6 | 0.01 | | 95 | 1 | |
| 7 | | 100 | 100 | 0 | |
| 8 | | 25 | 100 | 0 | |
| 9 | | 6.25 | 100 | 0 | |
| 10 | | 1.56 | 100 | 0 | |
| 11 | | 0.39 | 90 | 6 | |
| 12 | | 0.1 | 90 | 6 | |
| 13* | 10 | 100 | 0 | 100 | 98 |
| 14* | 2.5 | 25 | 0 | 100 | 86 |
| 15* | 0.62 | 6.25 | 5 | 95 | 76 |
| 16* | 0.16 | 1.56 | 13 | 86 | 69 |
| 17* | 0.04 | 0.39 | 58 | 40 | 35 |
| 18* | 0.01 | 0.1 | 95 | 1 | 7 |

*Compositions of the present invention

It is clear from the data set forth in Table 2, that the compositions of the present invention (Tests 13-17), with the exception of the lowest applied rate (Test 18), provide an unexpected increase in fungicidal effect on Asian soybean rust.

### Example 2

### Leaf Disc Test with Phakopsora pachyrhizi on Glyphosate Sensitive Soybean

A series of leaf disc tests were conducted to show the effects of tank mixtures of glyphosate and the ortho-substituted phenyl-amide (OPA) fungicides represented by structures F-5 and F-9 on Asian soybean rust. The soybean variety tested was brand Williams82 glyphosate sensitive soybean. The leaf source for the testing was the first trifoliate leaf. Six (6) repetitions for each formulation and at each rate were conducted. Treatment of the leaf with the recited active ingredients was conducted 4 weeks after planting. The leaves were inoculated with Phakopsora pachyrhizi (Asian soybean rust (ASR)) one (1) day after treatment. Evaluation of the leaf was conducted ten (10) days after inoculation and the mean percent infestation of the six repetitions is reported in Tables 3 and 4.

The glyphosate source was Touchdown® HiTech herbicide (Syngenta Corp.), containing the potassium salt of glyphosate and no adjuvant system. The compound OPA F-5 used was a compound of formula F-5, wherein the ratio of racemic compounds of formula F-3 (syn) to racemic compounds of formula F-4 (anti) was 9:1. The compound OPA F-5 used was a compound of formula F-5, wherein the ratio of racemic compounds of formula F-3 (syn) to racemic compounds of formula F-4 (anti) was 9:1. The compound OPA F-9 used was a compound of formula F-9, wherein the ratio of racemic compounds of formula F-7 (trans) to racemic compounds of formula F-8 (cis) was around 100:1. The fungicides used were EC100 formulations of OPA F-5 and OPA F-9 which are emulsion concentrates containing 100 ga.i./L. The rates of the active ingredients used in the tests are set in the table as mg active ingredient (a.i.)/L.

TABLE 3
Glyphosate + OPA F-5

| | Cpd in | Cpd in | | % activity | synerg. |
|---|---|---|---|---|---|
| | mg a.i./L | mg a.i./L | % activity | expected | Factor |
| Test | Glyphosate | OPA F-5 | observed | Colby | SF |
| 1 | | 20 | 34 | | |
| 2 | | 6.7 | 24 | | |
| 3 | | 2.2 | 5 | | |
| 4 | | 0.7 | 4 | | |
| 5 | | 0.2 | 4 | | |
| 6 | 600 | | 34 | | |
| 7 | 200.0 | | 0 | | |
| 8 | 66.7 | | 0 | | |
| 9 | 22.2 | | 14 | | |
| 10 | 7.4 | | 0 | | |
| 11 | 2.5 | | 0 | | |
| 12* | 600 | 20 | 100 | 57 | 1.8 |
| 13* | 200 | 6.7 | 100 | 24 | 4.1 |
| 14* | 66.7 | 2.2 | 100 | 5 | 21.7 |
| 15* | 22.2 | 0.7 | 100 | 18 | 5.6 |
| 16* | 66.7 | 20.0 | 100 | 34 | 2.9 |
| 17* | 22.2 | 6.7 | 100 | 35 | 2.8 |
| 18* | 7.4 | 2.2 | 100 | 5 | 21.7 |
| 19* | 2.5 | 0.7 | 14 | 4 | 3.7 |

It is clear from the data set forth in Table 3, that the compositions of the present invention (Tests 12, 13 and 15-17), with the exception of the lowest applied rates of OPA F-5 (Tests 14, 18 and 19), provide an unexpected increase in fungicidal effect on Asian soybean rust.

TABLE 4
Glyphosate + OPA F-9

| | Cpd in | Cpd in | | % activity | synerg. |
|---|---|---|---|---|---|
| | mg a.i./L | mg a.i./L | % activity | expected | Factor |
| Test | Glyphosate | OPA F-9 | observed | Colby | SF |
| 1 | | 20 | 100 | | |
| 2 | | 6.7 | 74 | | |
| 3 | | 2.2 | 24 | | |
| 4 | | 0.7 | 0 | | |
| 5 | | 0.2 | 0 | | |
| 6 | 200.0 | | 0 | | |
| 7 | 66.7 | | 0 | | |
| 8 | 22.2 | | 14 | | |
| 9 | 7.4 | | 0 | | |
| 10* | 200 | 6.7 | 100 | 74 | 1.4 |
| 11* | 66.7 | 2.2 | 93 | 24 | 3.8 |
| 12* | 22.2 | 0.7 | 64 | 14 | 4.4 |
| 13* | 7.4 | 2.2 | 64 | 24 | 2.6 |

It is clear from the data set forth in Table 4, that the compositions of the present invention (Tests 10-13) provide an unexpected increase in fungicidal effect on Asian soybean rust.

### Example 3

### Greenhouse Trial with Puccinia recondita on Glyphosate Sensitive Wheat

Greenhouse tests were conducted to show the effects of tank mixtures of glyphosate and the ortho-substituted phenyl-amide (OPA) fungicides represented by structures F-10, F-5 and F-9 on cereal rust Puccinia recondita. The wheat variety tested was brand Kanzler glyphosate sensitive wheat. Three (3) repetitions for each formulation and at each rate were conducted. Treatment of the plants with the recited active ingredients was conducted preventatively 16 days after planting. The leaves were inoculated with Puccinia recondita one (1) day after treatment. Evaluation of the leaf was conducted ten (9) days after inoculation and the mean percent infestation of the three repetitions is reported in Tables 5-7.

The glyphosate source was Zapp® QI herbicide containing the potassium salt of glyphosate as well as an adjuvant system. The compound OPA F-5 used was a compound of formula F-5, wherein the ratio of racemic compounds of formula F-3 (syn) to racemic compounds of formula F-4 (anti) was 9:1. The compound OPA F-5 used was a compound of formula F-5, wherein the ratio of racemic compounds of formula F-3 (syn) to racemic compounds of formula F-4 (anti) was 9:1. The compound OPA F-9 used was a compound of formula F-9, wherein the ratio of racemic compounds of formula F-7 (trans) to racemic compounds of formula F-8 (cis) was around 100:1. The fungicides used were EC 100 formulations of OPA F-10, OPA F-5 and OPA F-9 which are emulsion concentrates containing 100 ga.i./L. The rates of the active ingredients used in the tests are set in Tables 5-7 as mg active ingredient (a.i.)/L.

TABLE 5
Glyphosate + OPA F-10

| | Cpd in | Cpd in | | % activity |
|---|---|---|---|---|
| | mg a.i./L | mg a.i./L | % activity | expected |
| Test | Glyphosate | OPA F-10 | observed | Colby |
| 1 | 200 | | 42.0 | |
| 2 | 66 | | 0.0 | |
| 3 | | 6.6 | 0.0 | |
| 4 | | 2.2 | 0.0 | |
| 5* | 200 | 6.6 | 78.3 | 42.0 |
| 6* | 66 | 2.2 | 20.3 | 0.0 |

It is clear from the data set forth in Table 5, that the compositions of the present invention (Tests 5-6) provide an unexpected increase in fungicidal effect on cereal rust, Puccinia recondita.

TABLE 6
Glyphosate + OPA F-5

| | | Cpd in | | |
|---|---|---|---|---|
| | Cpd in | mg | | % activity |
| | mg a.i./L | a.i./L | % activity | expected |
| Test | Glyphosate | OPA F-5 | observed | Colby |
| 1 | 200 | | 42.0 | |
| 2 | 66 | | 0.0 | |
| 3 | | 6.6 | 0.0 | |
| 4 | | 2.2 | 0.0 | |
| 5* | 200 | 6.6 | 100.0 | 42.0 |
| 6* | 66 | 2.2 | 81.9 | 0.0 |

It is clear from the data set forth in Table 6, that the compositions of the present invention (Tests 5-6) provide an unexpected increase in fungicidal effect on cereal rust, Puccinia recondita.

TABLE 7
Glyphosate + OPA F-9

| | Cpd in | Cpd in | | % activity |
|---|---|---|---|---|
| | mg a.i./L | mg a.i./L | % activity | expected |
| Test | Glyphosate | OPA F-9 | observed | Colby |
| 1 | 200 | | 42.0 | |
| 2 | | 6.6 | 81.9 | |
| 3* | 200 | 6.6 | 98.5 | 89.5 |

It is clear from the data set forth in Table 7, that the composition of the present invention (Test 3) provide an unexpected increase in fungicidal effect on cereal rust, Puccinia recondita.

### Example 4

### Leaf Disc Test with Phakopsora pachyrhizi on Glyphosate Sensitive Soybean

A series of leaf disc tests were conducted to show the effects of tank mixtures of glyphosate and pesticides or plant activators on Asian soybean rust. The soybean variety tested was brand Williams82 glyphosate sensitive soybean. The leaf source for the testing was the first trifoliate leaf. Six (6) repetitions for each formulation and at each rate were conducted. Treatment of the leaf disks with the recited active ingredients was conducted 4 weeks after planting. The leaves were inoculated with Phakopsora pachyrhizi (Asian soybean rust (ASR)) one (1) day after treatment. Evaluation of the leaf was conducted ten (10) days after inoculation and the mean percent infestation of the six repetitions is reported in Tables 8-11.

As glyphosate source Touchdown® HiTech or Zapp® QI was used. The fungicides were used as commercial formulations: Bion® WG50 plant activator comprising acibenzolar-S-methyl (Syngenta Corp.), Opus® SC125 fungicide comprising epoxiconazole commercially (BASF AG), Tilt® EC250 fungicide comprising propiconazole (Syngenta Corp.), Quadris® SC250 fungicide comprising azoxystrobin (Syngenta Corp.). The rates of the active ingredients used in the tests are set in Tables 8-11 as mg active ingredient (a.i.)/L.

TABLE 8
Glyphosate + Acibenzolar

| | | Glyphosate | | | Colby |
|---|---|---|---|---|---|
| | Acibenzolar | Zapp QI | Leaf | Activity | Activity |
| | Bion WG50 | SL500 | attack | observed | expected |
| Test | mg a.i./L | mg a.i./L | % | % | % |
| Check | | | 69 | | |
| 1 | 20 | | 62 | 10 | |
| 2 | 6.7 | | 74 | 0 | |
| 3 | | 66.7 | 68 | 1 | |
| 4 | | 22.2 | 68 | 1 | |
| 5* | 20 | 66.7 | 56 | 19 | 11 |
| 6* | 6.7 | 22.2 | 56 | 19 | 1 |

It is clear from the data set forth in Table 8, that the compositions of the present invention (Tests 5-6) provide an unexpected increase in fungicidal effect on Asian soybean rust.

TABLE 9
Glyphosate + Epoxiconazole

| | | Glyphosate | | | |
|---|---|---|---|---|---|
| | | TD | | | Colby |
| | Epoxiconazole | HiTech | Leaf | Activity | Activity |
| | Opus SC125 | SL523 | attack | observed | expected |
| Test | mg a.i./L | mg a.i./L | % | % | % |
| Check | | | 77 | | |
| 1 | 0.2 | | 62 | 19 | |
| 2 | | 7.4 | 80 | 0 | |
| 3 | | 2.5 | 80 | 0 | |
| 4* | 0.2 | 7.4 | 38 | 51 | 19 |
| 5* | 0.2 | 2.5 | 26 | 66 | 19 |

It is clear from the data set forth in Table 9, that the compositions of the present invention (Tests 4-5) provide an unexpected increase in fungicidal effect on Asian soybean rust.

TABLE 10
Glyphosate + Propiconazole

| | | Glyphosate | | | |
|---|---|---|---|---|---|
| | | TD | | | Colby |
| | Propiconazole | HiTech | Leaf | Activity | Activity |
| | Tilt EC250 | SL523 | attack | observed | expected |
| Test | mg a.i./L | mg a.i./L | % | % | % |
| Check | | | 77 | | |
| 1 | 0.7 | | 74 | 4 | |
| 2 | | 22.2 | 80 | 0 | |
| 3 | | 7.4 | 80 | 0 | |
| 4* | 0.7 | 22.2 | 68 | 12 | 4 |
| 5* | 0.7 | 7.4 | 50 | 35 | 4 |

It is clear from the data set forth in Table 10, that the compositions of the present invention (Tests 4-5) provide an unexpected increase in fungicidal effect on Asian soybean rust.

TABLE 11
Glyphosate + Azoxystrobin

| | | Glyphosate | | | |
|---|---|---|---|---|---|
| | Azoxystrobin | TD | | | Colby |
| | Quadris | HiTech | Leaf | Activity | Activity |
| | SC250 | SL523 | attack | observed | expected |
| Test | mg a.i./L | mg a.i./L | % | % | % |
| Check | | | 80 | | |
| 1 | | 7.4 | 80 | 0 | |
| 2 | | 2.5 | 74 | 8 | |
| 3 | 0.7 | | 32 | 60 | |
| 4 | 0.2 | | 68 | 15 | |
| 5* | 74 | 0.7 | 20 | 75 | 60 |
| 6* | 2.5 | 0.2 | 50 | 38 | 21 |

It is clear from the data set forth in Table 11, that the compositions of the present invention (Tests 5-6) provide an unexpected increase in fungicidal effect on Asian soybean rust.

### Example 5

### Application on Whole Plants: Leaf Disc Test with Phakopsora pachyrhizi on Glyphosate Sensitive Soybean

A series of leaf disc tests were conducted to show the effects of tank mixtures of glyphosate and pesticides or plant activators on Asian soybean rust. The soybean variety tested was brand Williams82 glyphosate sensitive soybean. The leaf source for the testing was the first trifoliate leaf. Six (6) repetitions for each formulation and at each rate were conducted. Treatment of whole plants with the recited active ingredients was conducted 4 weeks after planting. After application, leaf disks were cut and inoculated with Phakopsora pachyrhizi (Asian soybean rust (ASR)) one (1) day after treatment. Evaluation of the leaf was conducted ten (10) days after inoculation and the mean percent infestation of the six repetitions is reported in Tables 12-14.

As glyphosate source Touchdown® HiTech or Zapp® QI was used. The fungicides were used as commercial formulations: Cantus® WG50 fungicide comprising boscalid (BASF AG), Quadris® SC250 fungicide and Bion® WG50 plant activator comprising acibenzolar-S-methyl. The rates of the active ingredients used in the tests are set in Tables 12-14 as g active ingredient (a.i.)/hectare (ha). The spray volume was 200 l/ha.

TABLE 12
Glyphosate + Boscalid

| | | Glyphosate | | | |
|---|---|---|---|---|---|
| | Boscalid | TD | | | Colby |
| | Cantus | HiTech | Leaf | Activity | Activity |
| | WG50 | SL523 | attack | observed | expected |
| Test | g a.i./ha | g a.i./ha | % | % | % |
| Check | | | 62 | | |
| 1 | 500 | | 50 | 19 | |
| 2 | 250 | | 58 | 7 | |
| 3 | | 200 | 58 | 7 | |
| 4* | 500 | 200 | 20 | 68 | 25 |
| 5* | 250 | 200 | 50 | 19 | 15 |

It is clear from the data set forth in Table 12, that the compositions of the present invention (Tests 4-5) provide an unexpected increase in fungicidal effect on Asian soybean rust.

TABLE 13
Glyphosate + Azoxystrobin

| | | Glyphosate | | | |
|---|---|---|---|---|---|
| | Azoxystrobin | TD | | | Colby |
| | Quadris | HiTech | Leaf | Activity | Activity |
| | SC250 | SL523 | attack | observed | expected |
| Test | g a.i./ha | g a.i./ha | % | % | % |
| Check | | | 62 | | |
| 1 | 100 | | 44 | 29 | |
| 2 | 50 | | 62 | 0 | |
| 3 | | 500 | 56 | 10 | |
| 4* | 100 | 500 | 28 | 56 | 36 |
| 5* | 50 | 500 | 35 | 44 | 10 |

It is clear from the data set forth in Table 13, that the compositions of the present invention (Tests 4-5) provide an unexpected increase in fungicidal effect on Asian soybean rust.

TABLE 14
Glyphosate + Acibenzolar-S-methyl

| | | Glyphosate | | | |
|---|---|---|---|---|---|
| | Acibenzolar | TD | | | Colby |
| | Bion | HiTech | Leaf | Activity | Activity |
| | WG50 | SL523 | attack | observed | expected |
| Test | g a.i./ha | g a.i./ha | % | % | % |
| Check | | | 62 | | |
| 1 | 60 | | 43 | 31 | |
| 2 | 10 | | 50 | 19 | |
| 3 | | 600 | 50 | 19 | |
| 4 | | 200 | 58 | 7 | |
| 5* | 10 | 600 | 35 | 44 | 35 |
| 6* | 60 | 200 | 18 | 72 | 36 |

It is clear from the data set forth in Table 14, that the compositions of the present invention (Tests 5-6) provide an unexpected increase in fungicidal effect on Asian soybean rust.

### Example 6

### Application on Whole Plants: Leaf Disc Test with Phakopsora pachyrhizi on Glyphosate Tolerant Soybean

Leaf disc tests were conducted to show the effects of tank mixtures of glyphosate and pesticides or plant activators on Asian soybean rust. The soybean variety tested was brand S40-R9 glyphosate tolerant soybean. The leaf source for the testing was the first trifoliate leaf. Six (6) repetitions for each formulation and at each rate were conducted. Treatment of application, leaf disks were cut and inoculated with Phakopsora pachyrhizi (Asian soybean rust (ASR)) one (1) day after treatment. Evaluation of the leaf was conducted ten (10) days after inoculation and the mean percent infestation of the six repetitions is reported in Tables 15-17.

As glyphosate source Touchdown® HiTech or Zapp® QI was used. The fungicides were used as commercial formulations: Bravo® SC500 fungicide comprising chlorothalonil (Syngenta Corp.), Score® EC250 fungicide comprising difenaconazole (Syngenta Corp.) and Mancozeb 80WP fungicide comprising mancozeb. The rates of the active ingredients used in the tests are set in Tables 15-17 as g active ingredient (a.i.)/hectare (ha). The spray volume was 200 l/ha.

TABLE 15
Glyphosate + Chlorothalonil

| | | Glyphosate | | | |
|---|---|---|---|---|---|
| | | TD | | | Colby |
| | Chlorothalonil | HiTech | Leaf | Activity | Activity |
| | Bravo SC500 | SL523 | attack | observed | expected |
| Test | g a.i./ha | g a.i./ha | % | % | % |
| Check | | | 60 | | |
| 1 | 1500 | | 50 | 17 | |
| 2 | 83.3 | | 80 | 0 | |
| 3 | | 1500 | 50 | 17 | |
| 4 | | 500 | 68 | 0 | |
| 5* | 83.3 | 1500 | 28 | 54 | 17 |
| 6* | 1500 | 500 | 20 | 67 | 17 |

It is clear from the data set forth in Table 15, that the compositions of the present invention (Tests 5-6) provide an unexpected increase in fungicidal effect on Asian soybean rust.

TABLE 16
Glyphosate + Difenoconazole

| | | Glyphosate | | | |
|---|---|---|---|---|---|
| | | TD | | | Colby |
| | Difenoconazole | HiTech | Leaf | Activity | Activity |
| | Score EC250 | SL523 | attack | observed | expected |
| Test | g a.i./ha | g a.i./ha | % | % | % |
| Check | | | 49 | | |
| 1 | 15 | | 50 | 0 | |
| 2 | 5 | | 50 | 0 | |
| 3 | | 1500 | 28 | 44 | |
| 4* | 15 | 1500 | 20 | 59 | 44 |
| 5* | 5 | 1500 | 20 | 59 | 44 |

It is clear from the data set forth in Table 16, that the compositions of the present invention (Tests 4-5) provide an unexpected increase in fungicidal effect on Asian soybean rust.

TABLE 17
Glyphosate + Mancozeb

| | | Glyphosate | | | |
|---|---|---|---|---|---|
| | | TD | | | Colby |
| | Mancozeb | HiTech | Leaf | Activity | Activity |
| | WP80 | SL523 | attack | observed | expected |
| Test | g a.i./ha | g a.i./ha | % | % | % |
| Check | | | 60 | | |
| 1 | 1500 | | 38 | 37 | |
| 2 | 750 | | 32 | 47 | |
| 3 | | 1500 | 50 | 17 | |
| 4 | | 500 | 68 | 0 | |
| 5* | 750 | 1500 | 20 | 67 | 56 |
| 6* | 1500 | 500 | 28 | 54 | 37 |

It is clear from the data set forth in Table 17, that the compositions of the present invention (Tests 5-6) provide an unexpected increase in fungicidal effect on Asian soybean rust.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

I claim:

1. A method of protecting crops of useful plants against attack by a phytopathogenic organism and/or the treatment of crops of useful plants infested by a phytopathogenic organism, said method comprising simultaneously applying glyphosate, including salts or esters thereof, and at least one fungicide having activity against the phytopathogenic organism to at least one member selected from the group consisting of the plant, a part of the plant and the locus of the plant.

2. The method of claim 1 wherein the fungicide comprises at least one member selected from the group consisting of azoles, 2-amino-pyrimidines, anilinopyrimidines, benzimidazoles, carboxamides, copper compounds, dicarboxamides, dithiocarbamates, guanidines, N-halomethylthiotetrahydrophthalimides, morpholines, nitrophenol-derivatives, organo-phosphorous derivatives, ortho-substituted phenyl- or thienyl-amide fungicides, pyridazine fungicides, pyrimidinyl carbinoles, pyrroles, strobilurins, triazolopyrimidine derivative fungicides, acibenzolar-S-methyl, anilazine, benthiavalicarb, blasticidin-S, chinomethionate, chloroneb, chlorothalonil, cyflufenamid, cymoxanil, dichlone, diclocymet, diclomezine, dicloran, diethofencarb, dimethomorph, flumorph, dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, cyazofamid, kasugamycin, mandipropamid, methasulfocarb, metrafenone, nicobifen, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide and the compound represented by formula B-1.1: 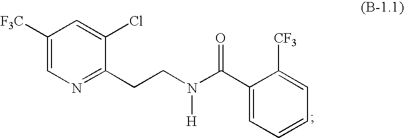
as well as mixtures thereof.

3. The method of claim 2 wherein the fungicide comprises at least one strobilurin fungicide.

4. The method of claim 3 wherein the strobilurin fungicide comprises at least one member selected from the group consisting of azoxystrobin, picoxystrobin, pyraclostrobin and trifloxystrobin.

5. The method of claim 2 wherein the fungicide comprises at least one triazolopyrimidine derivative of the formula I: 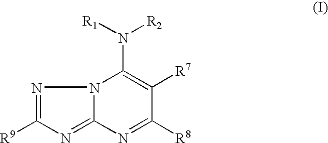
wherein
R¹ and R² together with the nitrogen atom to which they are attached form an optionally substituted heteromonocyclyl or heterobicyclyl;
R⁷ is an optionally substituted aryl or heteroaryl;
R⁸ is C₁-C₆alkyl, halogen or cyano; and
R⁹ is hydrogen, mercapto or C₁-C₃alkylthio.

6. The method of claim 5 wherein the triazolopyrimidine derivative has the formula

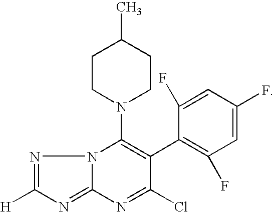

7. The method of claim 2 wherein the fungicide comprises at least one ortho-substituted phenyl- or thienyl-amide fungicide of formula II 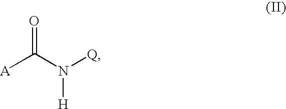
wherein A is 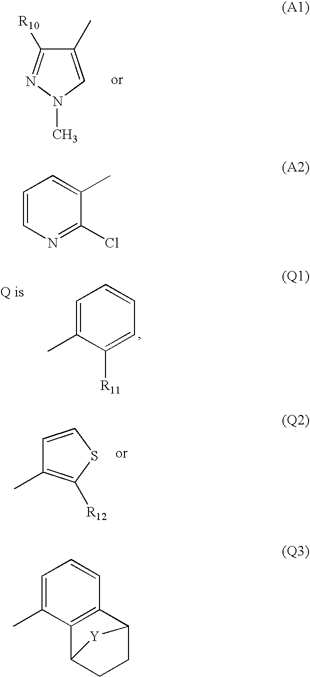
R₁₀ is difluoromethyl or trifluoromethyl;
R₁₁ is —CH₂—CH₂—CH(CH₃)₂, —CH(CH₃)—CH₂—CH(CH₃)₂, C₃₋₇cycloalkyl substituted by C₁₋₆alkyl or C₁₋₆haloalkyl; C₃₋₇cycloalkyl-C₃₋₇cycloalkyl or C₃₋₇cycloalkyl-C₃₋₇cycloalkyl substituted by C₁₋₆alkyl or C₁₋₆haloalkyl;
or R₁₁ is a phenyl group, which is substituted in the para-position by R₁₃;
R₁₃ is halogen or —C≡CR₁₄;
R₁₄ is C₁₋₆alkyl, C₁₋₆alkoxy-C₁₋₆alkyl or C₁₋₆haloalkyl;
R₁₂ is —CH₂—CH₂—CH(CH₃)₂ or —CH(CH₃)—CH₂—CH(CH₃)₂;
Y is —CHR₁₅—; and
R₁₅ is hydrogen or C₁₋₆alkyl.

8. The method of claim 7 wherein the ortho-substituted phenyl-amide fungicide comprises at least one member selected from the group consisting of

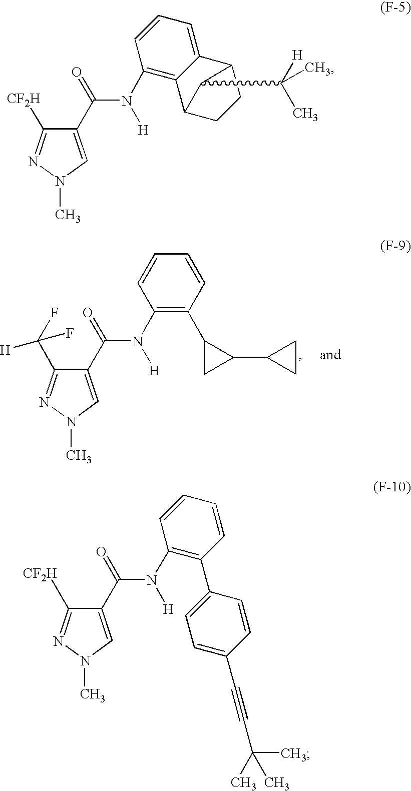

9. The method of claim 2 wherein the fungicide comprises at least two fungicides selected from the group consisting of acibenzolar, chlorothalonil, mandipropamid, ortho-substituted phenyl- or thienyl-amide fungicides, strobilurin fungicides, azole fungicides, pyridazine fungicides and triazolopyrimidine derivative fungicides.

10. The method of claim 9 wherein the fungicide comprises a mixture of at least one azole fungicide and at least one member selected from the group consisting of ortho-substituted phenyl- or thienyl-amide fungicides, strobilurin fungicides, pyridazine fungicides and triazolopyrimidine derivative fungicides.

11. The method of claim 1 wherein the crop is selected from the group consisting of canola, cereals, cotton, maize, soya and turf.

12. The method of claim 1 wherein the crop has been made tolerant to glyphosate as a result of conventional methods of breeding or genetic engineering.

13. The method of claim 1 wherein the crop is a glyphosate-sensitive crop.

14. The method of claim 1 wherein the phytopathogenic organism comprises at least one member of the order Uredinales, said method comprising simultaneously applying glyphosate, including salts or esters thereof, and at least one fungicide having activity against phytopathogenic organisms of the order Uredinales to at least one member selected from the group consisting of the plant, a part of the plant and the locus of the plant.

15. The method of claim 14 wherein the crop is selected from the group consisting of canola, cereals, cotton, maize and soya.

16. The method of claim 15 wherein the crop has been made tolerant to glyphosate as a result of conventional methods of breeding or genetic engineering.

17. The method of claim 15 wherein the crop is soya and the phytopathogenic organism is Phakopsora pachyrhizi.

18. The method of claim 15 wherein the crop is wheat and the phytopathogenic organism is Puccinia recondita.
